(19) United States
(12) Patent Application Publication
(10) Pub. No.: US 2022/0199277 A1
(43) Pub. Date: Jun. 23, 2022

(54) APPARATUS FOR PRODUCING RADIONUCLIDE AND METHOD FOR PRODUCING RADIONUCLIDE

(71) Applicant: Hitachi, Ltd., Tokyo (JP)

(72) Inventors: Takahiro TADOKORO, Tokyo (JP); Yuichiro UENO, Tokyo (JP); Yuuko KANI, Tokyo (JP)

(21) Appl. No.: 17/601,467

(22) PCT Filed: Feb. 12, 2020
(86) PCT No.: PCT/JP2020/005352

§ 371 Date: Oct. 5, 2021

(30) Foreign Application Priority Data
May 9, 2019 (JP) 2019-089200

(51) Int. Cl. G21G 1/12; G21K 5/08

(52) U.S. Cl. CPC G21G 1/12; G21G 2001/0089; G21K 5/08

(57) ABSTRACT

An object of the invention is to efficiently produce a radionuclide. While a fluid containing a raw material is circulated along a circulation passage, a first radionuclide is generated in the fluid from the raw material by irradiating the fluid with radiation rays midway along the circulation passage. Further, while the fluid is circulated along the circulation passage, a substance containing at least a part of the first radionuclide and a second radionuclide generated from the first radionuclide is taken out from the fluid, and the fluid containing the remaining raw material is returned to the circulation passage again for circulation.

### TECHNICAL FIELD

The present invention relates to an apparatus for producing a radionuclide using an accelerator, and more particularly, to an apparatus for producing a radionuclide in which a radionuclide that emits alpha rays, which is represented by actinium-225 (Ac-225) and is in great demand as a raw material for a therapeutic agent, can be efficiently produced with a small-sized and lightweight apparatus.

### BACKGROUND ART

In the related art, actinium-225 (Ac-225), which is a nuclide emitting alpha rays used for research and development as a raw material nuclide for a therapeutic agent, is produced by decay of thorium-229 (Th-229), which is a parent nuclide. Currently, there are only three facilities capable of supplying clinically available Ac-225 in the world, that is, the Institute for Transuranium Elements (ITU) in Karlsruhe, Germany, the Oak Ridge National Laboratory (ORNL) in America, and the Institute of Physics and Power Engineering (IPPE) in Obninsk, Russia.

Th-229 is not found in nature and is generated by decay of uranium-233 (U-233), but U-233 will not be produced in the future due to nuclear protection, so that a producible amount of Ac-225 in the world is only an amount generated by decay of Th-229 that is to be generated by decay of U-233 currently held in the world. The amount is sufficient for use in preclinical testing or the like, but a large shortage in the future is expected, and production using an accelerator is desired.

Regarding production of Ac-225 using an accelerator, a production method that uses an Ra-226 (p,2n) Ac-225 reaction in which naturally occurring radium-226 (Ra-226) is irradiated with protons accelerated in a cyclotron and two neutrons are emitted relative to one irradiation proton has been known from Patent Literature 1 or the like. In addition, the production method has been tested by the ORNL and the National Institutes for Quantum and Radiological Science and Technology, but has not been commercialized. The production method using the cyclotron has a problem that since a range of the accelerated protons in a Ra-226 target is short, mass production cannot be achieved even if the Ra-226 target is thickened. In addition, the production method has a problem that a temperature of the target rises because most energy of the accelerated protons is lost in the target, but it is difficult to remove heat, so that a current value and the energy cannot be improved for mass production.

As another method for producing Ac-225 using an accelerator, a method has been studied in which radium-225 (Ra-225) is produced by an Ra-226 (n,2n) Ra-225 reaction in which an Ra-226 target is irradiated with fast neutrons and two neutrons are emitted relative to one irradiation neutron, and Ac-225 is produced by beta decay of the obtained Ra-225. The accelerated neutrons are generated by irradiating a target of carbon or a target of a metal or the like having tritium occluded therein with deuterons accelerated by a cyclotron. The fast neutrons have a long range in Ra-226. Therefore, a large amount of Ac-225 can be produced by thickening Ra-226 serving as a raw material, but there is a problem that an apparatus is large in size since a large amount of generated fast neutrons are required to be shielded. In addition, there is also a problem that the entire apparatus structure is strongly radioactivated with the large amount of fast neutrons.

On the other hand, Patent Literature 2 discloses a purification method in which a Ra-226 target containing Ac-225 is dissolved in nitric acid, and then Ac-225 is separated and extracted from Ra-226 by chromatography.

Patent Literatures 3 and 4 disclose methods in which a target for braking radiation rays is irradiated with electrons accelerated by a small-sized electron beam accelerator to generate braking radiation rays (γ rays) and a raw material is irradiated with the generated braking radiation rays. As a result, a desired radionuclide can be produced by emitting neutrons from the raw material by a (γ,n) reaction. By the production method, molybdenum-99 (Mo-99) can be produced using molybdenum-100 (Mo-100) as a raw material. Further, technetium-99m (Te-99m) can be produced by beta decay of Mo-99. Te-99m is used for applications such as being administered to a subject during imaging with a single photon emission computed tomography (SPECT) apparatus.

Apparatuses of the above Patent Literatures 3 and 4 are configured to heat the raw material, make vaporized technetium oxide flow and move with gas, and separate the participating technetium from the gas, in order to take out the generated Te-99m.

### CITATION LIST

### Patent Literature

PTL 1: JP-T-2007-508531

PTL 2: JP-A-2009-527731

PTL 3: JP-A-2015-99117

PTL 4: JP-A-2016-80574

### SUMMARY OF INVENTION

### Technical Problem

In a method for generating a desired radionuclide by irradiating a raw material target with protons or neutrons which is described in Patent Literature 1 or the like, a temperature of the raw material target rises. Therefore, it is necessary to cool the raw material target, but it is not easy to cool the raw material target that is being irradiated with the protons or the neutrons from an accelerator. Therefore, it is difficult to perform continuous irradiation. In addition, since the desired radionuclide is generated on a surface or in an interior of the raw material target having a plate shape or the like, it is necessary to take out and dissolve the raw material target in order to perform extraction, and it is necessary to stop irradiation with the protons or the like during this period.

In addition, in methods of Patent Literatures 3 and 4, the raw material target is heated to a temperature equal to or higher than a boiling point of a radionuclide, which is desired to be taken out, in a state of being disposed at a position to be irradiated with braking radiation rays, and the vaporized radionuclide flows with gas and is separated. It is not easy to heat the raw material target, which is being irradiated with the radiation rays, to the temperature equal to or higher than the boiling point of the radionuclide desired to be taken out. Therefore, it is difficult to take out the radionuclide while continuously irradiating a raw material with the radiation rays. In addition, the boiling point of the radionuclide desired to be taken out needs to be higher than a boiling point of the raw material, and a combination of the raw material and the radionuclide to be taken out is limited.

For the reasons described above, it is difficult to improve production efficiency of the production methods of Patent Literatures 1, 3, and 4.

An object of the invention is to efficiently produce a radionuclide.

### Solution to Problem

In order to achieve the above object, an apparatus for producing a radionuclide of the invention includes: a circulation passage along which a fluid containing a raw material is circulated; a radiation generator configured to emit radiation rays to at least a part of the circulation passage to generate a first radionuclide from the raw material; and a separation device configured to take out, from the fluid circulating in the circulation passage, a substance containing at least a part of the first radionuclide and a second radionuclide generated from the first radionuclide, and return the fluid containing the remaining raw material to the circulation passage.

### Advantageous Effect

According to the invention, by circulating a fluid containing a raw material, the raw material can be supplied to an irradiation position of radiation rays, and a desired radionuclide can be separated by moving the fluid from the irradiation position to a separation device after the irradiation. In addition, since it is possible to perform temperature control by cooling or heating the circulating fluid at a position different from the irradiation position of the radiation rays, it is possible to efficiently produce the radionuclide at a predetermined temperature.

### BRIEF DESCRIPTION OF DRAWINGS

FIG. 1 is a block diagram showing a configuration of an apparatus for producing a radionuclide according to a first embodiment of the invention.

FIG. 2 is a graph showing a theoretical value of a reaction cross section of a reaction in which one neutron is generated by irradiating Ra-226 with gamma rays.

FIG. 3 is a block diagram showing a configuration of an apparatus for producing a radionuclide according to a second embodiment of the invention.

FIG. 4 is a block diagram showing a configuration of an apparatus for producing a radionuclide according to a third embodiment of the invention.

FIG. 5 is a block diagram showing a configuration of an apparatus for producing a radionuclide according to a fourth embodiment of the invention.

FIG. 6 is an example of adjusting a flow rate of a pump in the apparatus for producing a radionuclide according to the fourth embodiment of the invention.

FIG. 7 is a block diagram showing a configuration of an apparatus for producing a radionuclide according to a fifth embodiment of the invention.

FIG. 8 is a block diagram showing a configuration of an apparatus for producing a radionuclide according to a sixth embodiment of the invention.

FIG. 9 is a graph showing an example of amounts of Ra-225 and Ac-225 in a fluid 20 when the fluid 20 containing Ra-226 is irradiated with braking radiation rays 12 for 20 hours that is a time shorter than a half-life of Ra-225.

FIG. 10 is a graph showing an example of amounts of Ra-225 and Ac-225 in the fluid 20 when the fluid 20 containing Ra-226 is irradiated with the braking radiation rays 12 for 20 hours that is a time shorter than the half-life of Ra-225 and then Ac-225 is intermittently separated.

FIG. 11 is a diagram illustrating an example in which a circulation loop 21 of the apparatus for producing a radionuclide according to the sixth embodiment of the invention is moved to produce another raw material nuclide 15.

### DESCRIPTION OF EMBODIMENTS

An embodiment of the invention will be described.

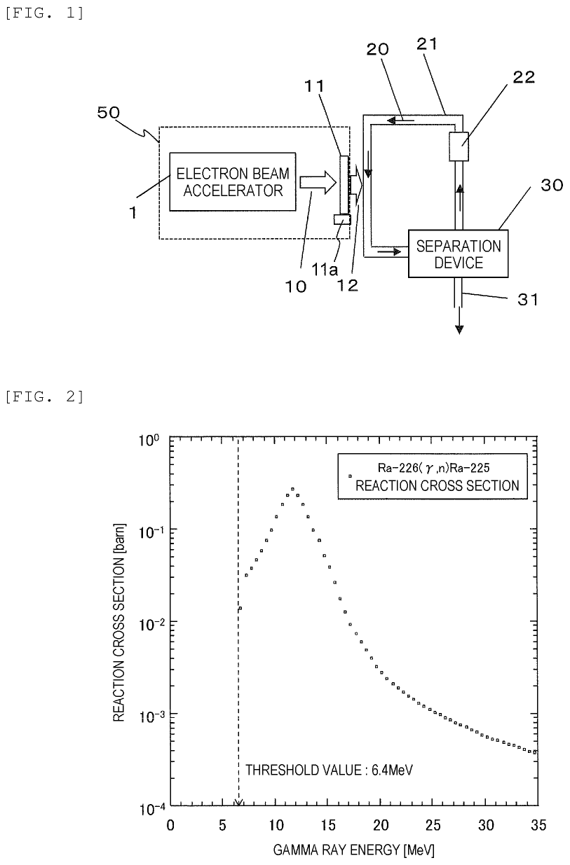

As shown in FIG. 1, an apparatus for producing a radionuclide of the present embodiment includes a circulation passage 21 along which a fluid 20 containing a raw material is circulated, a radiation generator 50, and a separation device 30.

In the present embodiment, the production apparatus irradiates the fluid 20 with radiation rays 12 from the radiation generator 50 midway along the circulation passage while circulating the fluid 20 containing the raw material along the circulation passage 21, so as to generate a first radionuclide in the fluid 20 from the raw material. Further, while the fluid 20 is circulated along the circulation passage 21, the separation device 30 takes out, from the fluid 20, a substance containing at least apart of the first radionuclide and a second radionuclide generated from the first radionuclide, and returns the fluid 20 containing the remaining raw material to the circulation passage again for circulation.

Thus, in the present embodiment, while the fluid 20 containing the raw material is circulated, the fluid is irradiated with radiation rays midway, then a desired radionuclide is taken out, the remaining raw material is returned to the circulation passage again, and whereby the desired radionuclide can be generated and the generated radionuclide can be taken out from the fluid 20 by continuously irradiating the fluid 20 with the radiation rays while the fluid containing the raw material is constantly circulated. Therefore, production efficiency of the radionuclide can be improved.

In addition, since the apparatus for producing a radionuclide of the present embodiment can repeatedly circulate the raw material that has not been converted into the radionuclide while having a simple configuration, the circulation passage functions as a supply mechanism for the raw material and as a movement mechanism for taking out the radionuclide, and further, also functions as a storage mechanism for the raw material or the generated radionuclide, so that the configuration of the apparatus can be simplified.

In addition, in the apparatus for producing a radionuclide of the present embodiment, since the fluid 20 can be constantly circulated, an excessive temperature rise of the raw material caused by irradiation with the radiation rays can be prevented. In addition, since a cooling apparatus or a heating apparatus for the fluid 20 can be easily disposed midway along the circulation passage and in a region that is not irradiated with the radiation rays, a temperature of the fluid 20 can also be easily cooled or heated to a desired temperature.

In addition, in the apparatus for producing a radionuclide of the present embodiment, a production amount of the radionuclide can be easily adjusted by adjusting a circulation speed of the fluid 20 and a concentration of the raw material included in the fluid 20 or adjusting a take-out amount of the radionuclide.

The radiation generator 50 may be any apparatus as long as the apparatus can irradiate the fluid 20 with radiation rays, and for example, an accelerator that accelerates charged particles can be used. Specifically, an electron beam accelerator, a cyclotron, a synchrotron, and a synchrocyclotron can be used, for example. Among these accelerators, the electron beam accelerator that emits an accelerated electron beam is suitable for a small-sized apparatus for producing a radionuclide since the electron beam accelerator can be set smaller in size and simpler than other accelerators. In particular, a linear electron beam accelerator is suitable because of being small in size.

For example, as the radiation generator 50, one including an electron beam accelerator 1 and a holding unit 11a that holds a target for braking radiation rays 11 at a position to be irradiated with an electron beam emitted from the electron beam accelerator can be used. Thus, since the fluid 20 can be irradiated with the braking radiation rays (γ rays) 12 generated from the target for braking radiation rays 11 irradiated with the electron beam, the radionuclide can be produced from the raw material by a (γ,n) reaction in which one neutron is generated by irradiating the raw material with one beam of braking radiation rays (γ ray).

As the fluid 20 circulated in the circulation passage 21, for example, any one of a dissolved solution in which the raw material is dissolved in a solvent, a dispersion solution in which the raw material is dispersed in a solvent, and dispersion gas in which the raw material is dispersed in gas can be used.

The raw material may be any raw material as long as a radionuclide is generated by irradiation with radiation rays.

For example, as the raw material, any one of Ra-226 (a number after an element symbol represents a mass number), Mo-100, Zn-68, Ge-70, Zr-91, Pd-106, and Hf-178, and oxides, nitrides, carbonates, hydrides, chlorides, and carbides of the above elements, specifically, molybdenum trioxide, zinc oxide, zinc carbonate, germanium monoxide, germanium dioxide, germanium hydride, zirconium dioxide, zirconium chloride, palladium hydride, hafnium chloride, hafnium carbide, or the like can be used.

When the fluid 20 is the dissolved solution of the raw material, any solvent may be used as long as the raw material can be dissolved therein. For example, when the raw material is Ra-226, an aqueous solution, a hydrochloric acid solution, or a nitric acid solution can be used as the fluid 20.

When the dispersion solution of the raw material is used as the fluid 20, slurry can be used which is obtained by using a solvent in which the raw material does not dissolve and dispersing particles of the raw material in the solvent.

When the dispersion gas is used as the fluid 20, inert gas in which fine particles of the raw material are dispersed can be used. In addition, gas containing vapor of the raw material may be used as the fluid 20.

Specifically, the apparatus for producing a radionuclide of the present embodiment can be configured such that the raw material is radium-226 (Ra-226), the aqueous solution, the hydrochloric acid solution, or the nitric acid solution thereof is used as the fluid 20, and the fluid is irradiated with the braking radiation rays from the radiation generator using the electron beam accelerator, and whereby radium-225 (Ra-225) as the first radionuclide can be generated in the fluid 20 by the (γ,n) reaction. Ra-225 decays in the fluid 20 and becomes actinium-225 (Ac-225) as the second radionuclide. The separation device is configured to separate actinium-225 (Ac-225) from the fluid 20.

At this time, since a reaction cross section (Ra-226(γ,n)Ra-225) of the (γ,n) reaction in which Ra-225 is generated from Ra-226 is substantially the same as a reaction cross section of a method (Ra-226(p,2n)Ac-225) for directly producing Ac-225 by a reaction in which two neutrons are emitted by irradiating Ra-226 with accelerated protons, the production efficiency can also be maintained.

In addition, in the apparatus for producing a radionuclide of the present embodiment, the raw material is molybdenum-100 (Mo-100) or molybdenum trioxide 100, the hydrochloric acid or nitric acid solution thereof is used as the fluid 20, and the fluid is irradiated with neutron rays from the radiation generator, and whereby molybdenum-99 (Mo-99) as the first radionuclide can be generated in the fluid by a (n,2n) reaction. Mo-99 decays and becomes technetium-99m (Te-99m) as the second radionuclide. In this case, the separation device 30 is configured to separate Te-99m from the fluid 20.

In the present embodiment, the separation device 30 may be any configuration as long as at least a part of the first radionuclide and the second radionuclide can be taken out. For example, the separation device 30 is configured such that a column filled with a stationary phase (or carrier) is used, and the fluid 20 passes through the column, and whereby the first radionuclide or the second radionuclide is separated from the raw material by chromatography, and the first radionuclide or the second radionuclide is taken out from a take-out portion 31. At this time, a liquid containing the raw material after separation is returned to a circulation loop 21 again.

In addition, the separation device 30 may be configured such that a material that binds to and precipitates the first radionuclide and the second radionuclide is added to the fluid 20, the first radionuclide and the second radionuclide are taken out by collecting and recovering precipitates, and the liquid containing the raw material that has not been precipitated is returned to the circulation loop 21.

When the fluid 20 is the dispersion solution (slurry), the separation device 30 may be configured such that the fluid is heated to a temperature equal to or higher than a boiling point of the first radionuclide or the second radionuclide, the first radionuclide or the second radionuclide is taken out by recovering and cooling vapor, and the solvent is added again to the raw material which has not become vapor and is returned to the circulation loop 21 as slurry.

In addition, the target for braking radiation rays 11 may be any target as long as braking radiation rays are generated by irradiating the target with an electron beam 10, and for example, a metal having a large atomic number such as tungsten, platinum, lead, or bismuth is used.

Hereinafter, embodiments of the invention will be described in more detail with reference to drawings.

### First Embodiment

A configuration of an apparatus for producing a radionuclide of a first embodiment will be described with reference to FIG. 1.

As shown in FIG. 1, the apparatus for producing a radionuclide of the present embodiment generates the braking radiation rays (γ rays) 12 by irradiating the target for braking radiation rays 11 held by the holding unit 11a with the electron beam 10 accelerated by the electron beam accelerator 1. A pump 22 that circulates the fluid 20 and the separation device 30 that separates a desired radionuclide are disposed midway along the circulation passage (hereinafter, referred to as the circulation loop) 21.

The fluid (here, a solution) 20 containing the raw material circulates in the circulation loop 21.

The fluid 20 containing the raw material is irradiated with the braking radiation rays 12 emitted from the target for braking radiation rays 11 when passing through the circulation loop 21 disposed close to the target for braking radiation rays 11. As a result, the first radionuclide is generated from the raw material nuclide in the fluid 20 by the (γ,n) reaction in which one neutron is generated by irradiating the fluid 20 with one beam of braking radiation rays.

The fluid 20 containing the generated radionuclide and the raw material further moves in the circulation loop 21, during which the first radionuclide partially decays and becomes the second radionuclide. The fluid 20 reaches the separation device 30, and at least a part of the first radionuclide and the second radionuclide is taken to the outside by the separation device 30 from the take-out portion 31. The fluid containing the first radionuclide, the second radionuclide, and the raw material, which have not been taken out, moves again through the circulation loop 21, and is irradiated with the braking radiation rays 12.

The above reaction and separation is repeated each time the fluid 20 circulates once in the circulation loop 21.

For example, Ra-226 can be used as the raw material, and the aqueous solution, the hydrochloric acid solution, or the nitric acid solution of the raw material can be used as the fluid 20. The fluid 20 containing the raw material Ra-226 repeatedly circulates in the circulation loop 21, and each time the fluid 20 is irradiated once with the braking radiation rays 12, Ra-225 is generated from the raw material nuclide Ra-226 in the fluid 20 by the (γ,n) reaction. The generated Ra-225 undergoes beta decay with a half-life of 14.8 days, and a part thereof becomes Ac-225 which is a progeny nuclide during circulating. Therefore, the fluid 20 flowing through the circulation loop 21 contains the raw material Ra-226 and the generated Ra-225 and Ac-225.

In the separation device 30, Ac-225 is taken out by the column or the like.

As described above, Ac-225, which is a raw material for a therapeutic agent, can be produced by the production apparatus of the present embodiment.

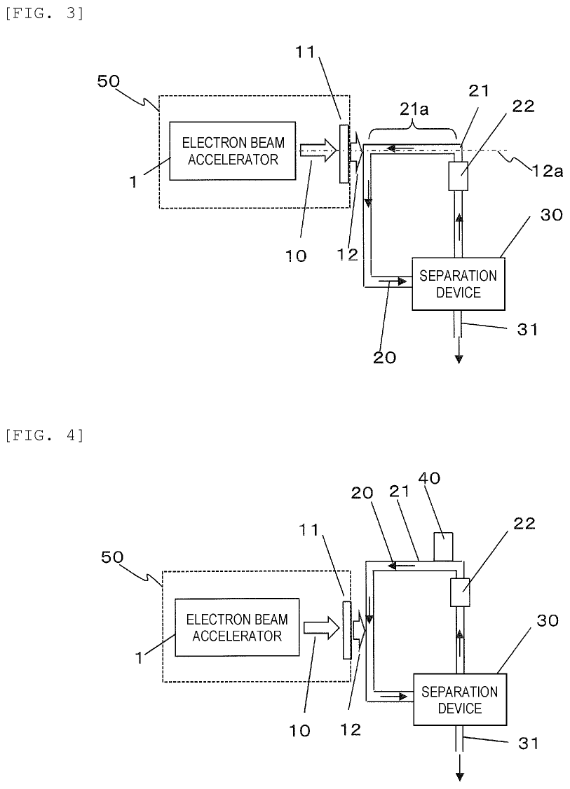

FIG. 2 shows a theoretical value of a reaction cross section of a reaction in which one neutron is generated by irradiating Ra-226 with gamma rays. From FIG. 2, it can be seen that Ra-225 can be generated by irradiating Ra-226 with the γ rays (radiation rays) 12 having energy equal to or higher than a threshold value.

The electron beam accelerator 1 can be made smaller in size as compared with a proton accelerator or a heavy particle accelerator if acceleration energy and an acceleration current value are substantially the same. In addition, a generation cross section of the (γ,n) reaction in which Ra-225 is generated from Ra-226 is substantially the same as a cross section in which Ac-225 is generated by a method (Ra-226(p,2n)Ac-225) for irradiating Ra-226 with the accelerated protons. Therefore, the apparatus for producing a radionuclide of the present embodiment in which the electron beam accelerator 1 is used can be made smaller in size than an apparatus for producing a radionuclide using the proton accelerator or the heavy particle accelerator.

In addition, when an electron linear accelerator is used, the number of neutrons generated from the target for braking radiation rays is relatively small and most of the neutrons are the braking radiation rays that can be easily shielded by lead or the like, so that a shielding of the target for braking radiation rays and a periphery thereof can be made smaller in size, and thus the apparatus for producing a radionuclide can be made smaller in size.

In FIG. 1, for convenience of illustration, the electron beam accelerator 1 is shown to be smaller than the circulation loop 21, but the actual electron beam accelerator 1 has a length of several meters, whereas the circulation loop 21 can have a loop diameter of 1 m or less.

In the present embodiment, it is of course also possible to use the proton accelerator or the heavy particle accelerator as the radiation generator. For example, the above (Ra-226(p,2n)Ac-225) reaction may be used, or (Ra-226(n,2n)Ra-225) reaction may be used.

In the apparatus for producing a radionuclide of the present embodiment, most of Ra-226, which is the raw material nuclide in the fluid 20, remains as the raw material nuclide instead of nuclear-reacting with the braking radiation rays 12. In addition, since Ra-225 generated by the braking radiation rays 12 reacting with the raw material is difficult to be separated and purified from Ra-226 in the separation device 30, Ra-226 and Ra-225 circulate in a state of being contained in the fluid 20. Ra-225 is also irradiated with the braking radiation rays 12 each time the fluid 20 circulates once, but since an amount of Ra-226 in the fluid 20 is very small as compared with that of Ra-226, an amount of a nuclide generated by a nuclear reaction between Ra-225 and the braking radiation rays is very small and causes no problem.

Ra-225 undergoes the beta decay and decays into Ac-225 while the fluid 20 circulates in the circulation loop 21, and Ac-225 is separated and taken out from the take-out portion 31 each time the fluid 20 passes through the separation device 30. Therefore, Ac-225 can be taken out continuously or as needed from the take-out portion 31, and the circulation loop 21 can also functions to store the raw material nuclide.

Ac-225, which is useful as the raw material of the therapeutic agent, becomes Fr-221 which is a progeny nuclide with a half-life of 10.0 days. Fr-221 becomes At-217 with a half-life of 4.9 minutes, and At-217 becomes Bi-213 with a half-life of 32 milliseconds. Ac-225 and the progeny nuclides thereof are useful as the raw material for the therapeutic agent, but Ra-226 and Ra-225 are unnecessary nuclides as the raw material for the therapeutic agent since Ra-226 and Ra-225 are not nuclides that emit alpha rays, and need to be separated and purified from Ac-225. By the radiation generator of the present embodiment, Ra-226 and Ra-225 can be separated from Ac-225 and circulated again and reused.

Thus, the radiation generator of the first embodiment can efficiently produce the radionuclide by irradiating the fluid with the radiation rays while circulating the fluid containing the raw material.

### Second Embodiment

An example of an apparatus for producing a radionuclide of a second embodiment will be described with reference to FIG. 3.

The apparatus for producing a radionuclide of the second embodiment has a configuration similar to that of the apparatus of FIG. 1 of the first embodiment, but the second embodiment is different from the first embodiment in that a linear region 21a is provided in the circulation loop 21 and the radiation generator 50 is disposed such that a central axis 12a of the braking radiation rays 12 passes through the linear region 21a of the circulation loop 21.

In the configuration of the apparatus for producing a radionuclide of the second embodiment, since a distance that the braking radiation rays 12 pass through the fluid 20 in the circulation loop 21 is longer than that in a case where the fluid 20 is irradiated with the braking radiation rays so as to traverse the circulation loop 21 as shown in FIG. 1, the amount of the first radionuclide generated from the raw material in the fluid 20 can be increased. As a result, the production efficiency of the radionuclide can be improved. Hereinafter, description will be made in more detail.

As in the first embodiment, the radiation generator 50 of the second embodiment generates the braking radiation rays by irradiating the target for braking radiation rays 11 with an electron beam 2 accelerated by the electron beam accelerator 1. When the target for braking radiation rays 11 is irradiated with an electron beam having relatively high energy such as the electron beam 2 emitted from the electron beam accelerator 1, the central axis 12a at which intensity of the generated braking radiation rays 12 is the largest coincides with an irradiation axis direction of the electron beam.

Therefore, in the apparatus of the second embodiment, a portion (the linear region 21a) of the circulation loop 21 is provided such that a longitudinal direction thereof coincides with the central axis 12a at which the strong braking radiation rays 12 are generated.

A range of the braking radiation rays 12 in the fluid (solution) 20 containing the raw material is very long as compared to a range of the charged particles such as protons or deuterons. Therefore, by providing the portion (the linear region 21a) of the circulation loop 21 such that the longitudinal direction thereof coincides with the central axis 12a of the braking radiation rays 12, a reaction amount of the raw material nuclide in the circulation loop 21 with the braking radiation rays increases. Therefore, when the fluid 20 contains Ra-226 as the raw material as in the example described in the first embodiment, the amount of Ra-225 generated by the production apparatus of the second embodiment is larger than that generated by the production apparatus of the first embodiment.

The present embodiment has a configuration in which the linear region 21a is provided in the circulation loop 21 and the longitudinal direction of the linear region 21a coincides with the central axis 12a of the braking radiation rays 12, but the invention is not limited to this configuration, and other structures can be provided in the circulation loop 21 to increase the distance that the braking radiation rays 12 pass through the circulation loop 21. For example, since intensity of the braking radiation rays 12 is distributed such that, centering on the position where the target for braking radiation rays 11 is irradiated with the electron beam 10, the intensity is the strongest in an axial direction (central axis 12a) of the electron beam 10 and becomes weaker as an angle formed with the central axis 12a increases, a diameter of the circulation loop 21 in a direction of the central axis 12a may be increased.

### Third Embodiment

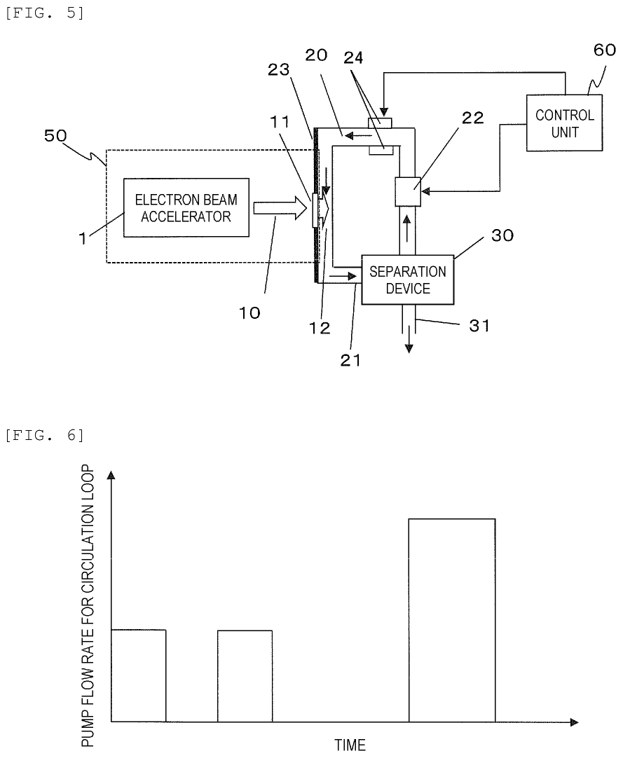

An example of an apparatus for producing a radionuclide of a third embodiment will be described with reference to FIG. 4.

The apparatus for producing a radionuclide of the third embodiment has a configuration similar to that of the apparatus of the first embodiment, but is different from that of the first embodiment in that a discharge port 40 for gas is provided in the circulation loop 21. A gaseous nuclide generated by decay of the radionuclide contained in the fluid 20 can be discharged by providing the discharge port 30. As a result, the fluid 20 can be prevented from containing gas, and the fluid 20 can be stably circulated by the pump 22. Hereinafter, description will be made in detail.

When Ra-226 is used as the raw material nuclide in the circulation loop for a radionuclide production solution, Ra-226 undergoes alpha decay with a half-life of 1600 years to produce radon-222 (Rn-222). It is known that Rn-222 belongs to a rare gas element and exists as gas of a monatomic molecule in a standard state. For example, assuming that the solvent for the fluid 20 is water at 20° C., since a solubility of Rn-222 in the water is 24.5 ml per 100 ml, Rn-222 exists as gas in the fluid 20 when there is a water-insoluble amount of Rn-222 in the circulation loop 21.

When the gas is mixed in the fluid 20, the pump 22 may not operate normally. In addition, since a volume of the gas is large, when the gas is mixed in the fluid 20, an amount of the raw material nuclide Ra-226 contained in the fluid 20 in a region to be irradiated with the braking radiation rays 12 is reduced. Therefore, the amount of Ra-225 generated from the raw material is reduced.

Therefore, in the present embodiment, the gas contained in the fluid 20 is discharged by providing the discharge port in the circulation loop 21. As a result, the above inconvenience due to the gas being mixed in the fluid 20 can be eliminated, and the desired nuclide can be stably produced.

Discharging the gas from the discharge port 40 may not necessarily be performed at all times, and may be performed at a regular or irregular discharge timing depending on a generation amount of the gaseous nuclide such as Rn-222, a solubility of the gas in the solution of the fluid 20, and the like.

### Fourth Embodiment

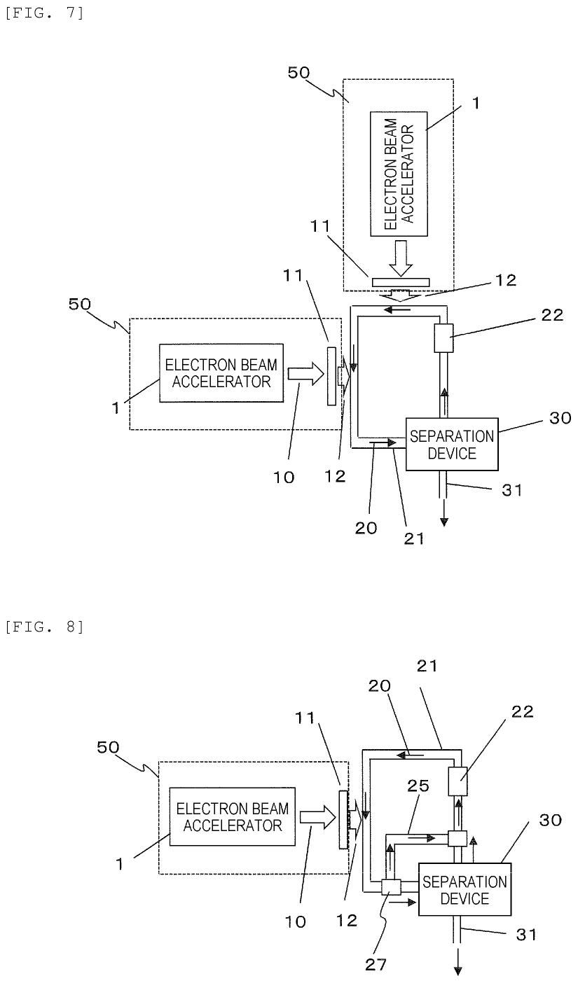

An example of an apparatus for producing a radionuclide of a fourth embodiment will be described with reference to FIGS. 5 and 6.

The apparatus for producing a radionuclide of the fourth embodiment has a configuration similar to that of the first embodiment, but is different from the first embodiment in that all or a part of a piping 23 of the circulation loop 21 is made of a material of the target for braking radiation rays 11 and also serves as the target for braking radiation rays 11. The radiation generator 50 emits the electron beam 10 toward the piping of the circulation loop 21 made of the material that generates the braking radiation rays. As a result, the braking radiation rays 12 are generated from the piping, and the fluid 20 flowing inside the circulation loop 21 is irradiated with the braking radiation rays 12.

A metal having a large atomic number such as tungsten or platinum can be used as the material constituting all or a part of the piping 23 of the circulation loop 21, which also serves as the target for braking radiation rays 11.

Thus, since a part of the piping of the circulation loop 21 also serves as the target for braking radiation rays 11, a distance from a position where the braking radiation rays 12 are generated (target 11) to the raw material nuclide in the fluid 20 is shortened. As a result, the intensity of the braking radiation rays 12 with which the raw material nuclide is irradiated increases, so that the generation amount of the desired radionuclide (for example, Ra-225) increases.

In the target for braking radiation rays 11, a temperature of the target 11 rises due to loss of the energy of the electron beam 10, but the target 11 can be cooled by the fluid 20 since the fluid 20 circulates. That is, the fluid 20 can cool the target 11 by receiving heat by heat conduction at a position in contact with the target for braking radiation rays 11 and radiating the received heat in a region of the circulation loop 21 which does not serve as the target 11.

Further, a cooling unit 24 that cools the fluid 20 may be disposed midway along the circulation loop 21. As a result, the target for braking radiation rays 11 can be efficiently cooled by the fluid 20.

In addition, a temperature adjustment unit having both heating and cooling functions may be disposed instead of the cooling unit 24. As a result, depending on a heat generation temperature of the target for braking radiation rays 11, the temperature adjustment unit 24 can heat or cool the fluid 20 to maintain a temperature at which the radionuclide production solution is not vaporized or a temperature at which a solubility of the raw material nuclide is maximized.

In addition, as shown in FIG. 5, a control unit 60 that controls the temperature adjustment unit 24 and the pump 22 may be disposed. As shown in FIG. 6, the control unit 60 controls an operation time and a stop time of the pump 22 and a flow rate during an operation. In addition, the control unit 60 controls an operation of the temperature adjustment unit 24 of heating or cooling the fluid 20. Thus, the control unit 60 can adjust the temperature of the fluid 20 to a predetermined temperature range by controlling both the pump 22 and the temperature adjustment unit 24.

In addition, the control unit 60 may adjust the flow rate of the pump 22 according to an amount of the radionuclide desired to be taken out from the separation device 30. That is, when it is desired to reduce the amount of the radionuclide to be taken out from the separation device 30, the control unit 60 reduces the flow rate of the pump 22. Thus, the production amount can be controlled by adjusting the flow rate of the pump 22.

### Fifth Embodiment

An example of an apparatus for producing a radionuclide of a fifth embodiment will be described with reference to FIG. 7.

The apparatus for producing a radionuclide of the fifth embodiment has a configuration similar to that of the apparatus of the first embodiment, but is different from the first embodiment in that a plurality of radiation generators 50 are provided around the circulation loop 21. Each of the plurality of radiation generators 50 irradiates the circulation loop 21 with radiation rays. For example, in a case where the circulation loop 21 is irradiated with the braking radiation rays from each of two radiation generators 50 having the same structure as shown in FIG. 7, twice the amount of the radionuclide (for example, Ra-225) can be produced as compared with a case where one radiation generator 50 of FIG. 1 is used, so that the production efficiency can be improved.

In addition, since the apparatus of the fifth embodiment includes the plurality of radiation generators 50, even when one radiation generator 50 fails, the production can be continued by using another one, so that a risk that the generated nuclide cannot be produced at all can be reduced.

In addition, by combining the configurations of the present embodiment and the fourth embodiment, a metal having a large atomic number such as tungsten or platinum may be used for all the piping of the circulation loop 21 or a part of a plurality of locations of the piping of the circulation loop 21, and the piping of the circulation loop 21 may serve as the target for braking radiation rays 11 at the plurality of locations.

### Sixth Embodiment

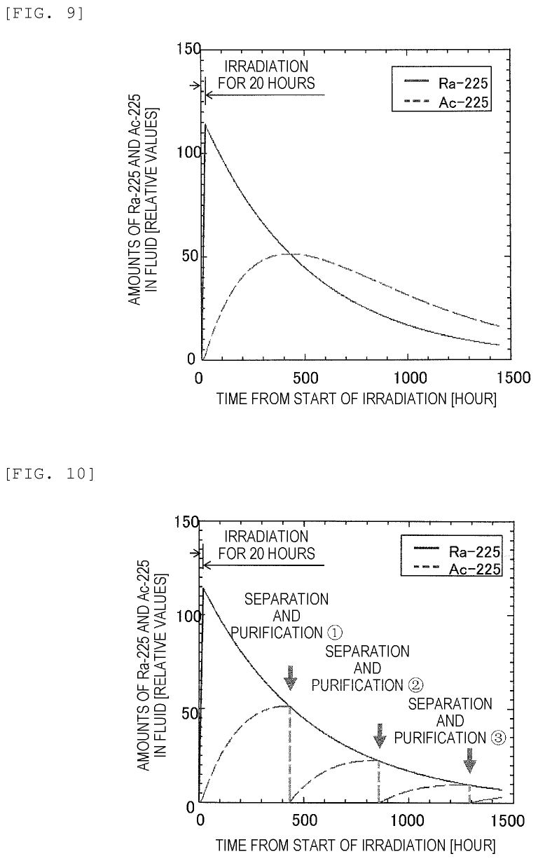

An example of an apparatus for producing a radionuclide of a sixth embodiment will be described with reference to FIG. 8.

The apparatus for producing a radionuclide of the sixth embodiment has a configuration similar to that of the apparatus of the first embodiment, but is different from the first embodiment in that the circulation loop 21 is provided with a bypass passage 25, which bypasses the separation device 30, and a flow passage switch 27.

Since the apparatus for producing a radionuclide of the first embodiment has the configuration where the fluid 20 passes through the separation device 30 each time the fluid 20 circulates once in the circulation loop 21, the radionuclide is constantly taken out from the separation device 30 during operation of the apparatus. In contrast, in the apparatus for producing a radionuclide of the sixth embodiment, the bypass passage 25 is provided, and whether the fluid 20 flows through the bypass passage 25 or flows through the separation device 30 can be selected by the flow passage switch 27. As a result, even during the operation of the apparatus, the radionuclide is not taken out when the fluid 20 flows through the bypass passage 25, and the radionuclide is taken out only when the fluid 20 flows through the separation device 30. Therefore, according to the apparatus for producing a radionuclide of the sixth embodiment, a timing at which the radionuclide is taken out can be controlled. For example, as in the following example, Ac-225 can be produced from Ra-226 which is the raw material.

Ra-225 produced by irradiating the fluid 20 containing Ra-226 which is the raw material with the braking radiation rays 12 undergoes beta decay with the half-life of 14.8 days and becomes Ac-225 which is the progeny nuclide. FIG. 9 shows an example of amounts of Ra-225 and Ac-225 in the fluid 20 when the fluid 20 containing Ra-226 is irradiated with the braking radiation rays 12 for 20 hours that is a time shorter than the half-life of Ra-225. In the example of FIG. 9, an irradiation time of the braking radiation rays 12 is much shorter than the half-life of Ra-225, so that the amount of Ra-225 increases with time during irradiation with the braking radiation rays 12 and gradually decreases due to beta decay with the half-life of 14.8 days after the end of the irradiation. On the other hand, Ac-225 increases with a delay from an increase of Ra-225 during irradiation with the braking radiation rays 12, increases in response to the gradual decrease of Ra-225 caused by beta decay thereof even after the end of the irradiation, and reaches a maximum amount at about 428 hours after the irradiation, but decreases as Ac-225 is changed to Fr-221 which is the progeny nuclide with the half-life of 10.0 days.

At this time, the apparatus for producing a radionuclide of the present embodiment can set the flow passage switch 27 so as to allow the fluid 20 to pass through the separation device 30 during the irradiation and after the irradiation, and Ac-225 is continuously separated and taken out from the take-out portion 31.

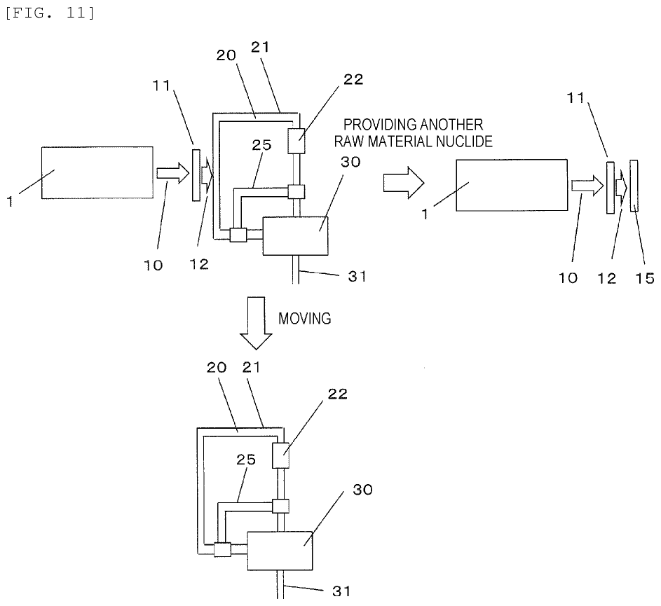

Further, as shown in FIG. 10, in the apparatus for producing a radionuclide of the present embodiment, Ac-225 can be intermittently taken out.

FIG. 10 shows an example of amounts of Ra-225 and Ac-225 in the fluid 20 when the fluid 20 containing Ra-226 is irradiated with the braking radiation rays 12 for 20 hours that is a time shorter than the half-life of Ra-225 as in FIG. 9. The increase and the gradual decrease of Ra-225 in FIG. 10 are similar to those in FIG. 9. In addition, in FIG. 10, Ac-225 increases and reaches a maximum amount at about 428 hours after the irradiation with the braking radiation rays 12, which is also similar to that in FIG. 9.

In the example of FIG. 10, the flow passage switch 27 causes the fluid 20 to flow through the bypass passage 25 during a period of 428 hours after the irradiation with the braking radiation rays 12, but the flow passage switch 27 causes the fluid 20 to flow through the separation device 30 at a time point of 428 hours after the irradiation, and all of Ac-225 in the fluid 20 in the circulation loop 21 is taken out (first separation and purification).

After the first take-out, the flow passage switch 27 causes the fluid 20 to flow through the bypass passage 25 or the circulation in the circulation loop 21 is stopped. Even when the fluid 20 is not irradiated with the braking radiation rays 12, Ac-225 is generated by the beta decay of Ra-225 already generated in the fluid 20, so that the amount of Ac-225 increases again and reaches a maximum amount again at about 428 hours after the first take-out as shown in FIG. 10. Therefore, in the example of FIG. 10, the flow passage switch 27 causes the fluid 20 to flow through the separation device 30, and all of Ac-225 in the fluid 20 in the circulation loop 21 is taken out (second separation and purification).

After the second take-out, the flow passage switch 27 causes the fluid 20 to flow through the bypass passage 25 or the circulation in the circulation loop 21 is stopped, and at about 428 hours after the second take-out, the flow passage switch 27 causes the fluid 20 to flow through the separation device 30 and all of Ac-225 in the fluid 20 in the circulation loop 21 is taken out (third separation and purification).

Thus, in the apparatus of the sixth embodiment, after the irradiation with the braking radiation rays 12, Ac-225 may be continuously taken out, or may be intermittently taken out.

In the apparatus for producing a radionuclide of the sixth embodiment, the radiation generator 50 is not necessary while Ac-225 is continuously or intermittently taken out after the irradiation with the braking radiation rays 12, and therefore, as shown in FIG. 11, the circulation loop 21 is moved away from in front of the radiation generator 50 and another raw material nuclide 15 or another circulation loop 21 is provided in a portion where the circulation loop 21 has been moved, and whereby the radionuclide in the another nuclide or the another circulation loop 21 can be produced. A form of the another raw material nuclide 15 may be a solid or a liquid.

### REFERENCE SIGN LIST

1: electron beam accelerator
10: electron beam
11: target for braking radiation rays
12: braking radiation rays
15: another raw material nuclide
20: fluid
21: circulation loop (circulation passage)
22: pump
23: portion where target material is used for piping material
24: cooling unit
25: bypass passage
30: separation device
31: take-out portion
40: discharge port

1. An apparatus for producing a radionuclide, comprising:
a circulation passage along which a fluid containing a raw material is circulated;
a radiation generator configured to emit radiation rays to at least a part of the circulation passage to generate a first radionuclide from the raw material; and
a separation device configured to take out, from the fluid circulating in the circulation passage, a substance containing at least a part of the first radionuclide and a second radionuclide generated from the first radionuclide, and return the fluid containing the remaining raw material to the circulation passage.

2. The apparatus for producing a radionuclide according to claim 1, wherein
the radiation generator includes an electron beam accelerator configured to emit an accelerated electron beam and a holding unit configured to hold a target for braking radiation rays at a position to be irradiated with the electron beam emitted from the electron beam accelerator, and the radiation generator is configured to irradiate the fluid with braking radiation rays generated from the target for braking radiation rays irradiated with the electron beam.

3. The apparatus for producing a radionuclide according to claim 1, wherein
the fluid is any one of a solution in which the raw material is dissolved in a solvent, a dispersion solution in which the raw material is dispersed in a solvent, and dispersion gas in which the raw material is dispersed in gas.

4. The apparatus for producing a radionuclide according to claim 1, wherein
a part of the circulation passage has a linear region in a direction in which the fluid flows,
the radiation generator is disposed such that a central axis of the radiation rays emitted by the radiation generator passes through the linear region of the circulation passage.

5. The apparatus for producing a radionuclide according to claim 1, wherein
the circulation passage is provided with a discharge port through which a gaseous nuclide generated by decay of the radionuclide contained in the fluid is discharged.

6. The apparatus for producing a radionuclide according to claim 1, wherein
the at least a part of the circulation passage is made of a material that generates braking radiation rays by being irradiated with an electron beam,
the radiation generator is an electron beam accelerator configured to emit an accelerated electron beam, and is configured to emit the electron beam toward the circulation passage made of the material that generates the braking radiation rays so as to irradiate the fluid flowing in the circulation passage with the braking radiation rays.

7. The apparatus for producing a radionuclide according to claim 1, further comprising:
a pump provided in the circulation passage; and
a control unit configured to control the pump, wherein
the control unit is configured to adjust at least one of an operation time and a stop time of the pump, and a flow rate during a pump operation.

8. The apparatus for producing a radionuclide according to claim 1, wherein
the circulation passage is provided with a cooling unit configured to cool the fluid.

9. The apparatus for producing a radionuclide according to claim 2, wherein
the radiation generator includes a plurality of radiation generators, and the radiation generators are configured to respectively irradiate different portions of the circulation passage with braking radiation rays.

10. The apparatus for producing a radionuclide according to claim 1, wherein
the circulation passage is provided with a bypass passage configured to bypass the separation device.

11. A method for producing a radionuclide, comprising:
irradiating, while a fluid containing a raw material is circulated along a circulation passage, the fluid with radiation rays midway along the circulation passage to generate a first radionuclide in the fluid from the raw material; and
while the fluid is circulated along the circulation passage, taking out, from the fluid, a substance containing at least a part of the first radionuclide and a second radionuclide generated from the first radionuclide, and returning the fluid containing the remaining raw material to the circulation passage again for circulation.

12. The method for producing a radionuclide according to claim 11, wherein
the radiation rays are braking radiation rays generated by irradiating a target with accelerated electrons.

13. The method for producing a radionuclide according to claim 11, wherein
the raw material is radium-226 (Ra-226), the first radionuclide is radium-225 (Ra-225), and the second radionuclide is actinium-225 (Ac-225).

14. The method for producing a radionuclide according to claim 11, wherein
the raw material is molybdenum-100 (Mo-100) or molybdenum trioxide 100, the first radionuclide is molybdenum-99 (Mo-99), and the second radionuclide is technetium-99m (Te-99m).

15. The method for producing a radionuclide according to claim 11, wherein
the fluid is any one of a solution in which the raw material is dissolved in a solvent, a dispersion solution in which the raw material is dispersed in a solvent, and dispersion gas in which the raw material is dispersed in gas.
